(19) United States
(12) Patent Application Publication
(10) Pub. No.: US 2003/0093678 A1
(43) Pub. Date: May 15, 2003

(54) Server-side digital signature system

(76) Inventors: John J. Bowe, Belmont, MA (US); Frederick J. Hirsch, Melrose, MA (US); Daniel Lanz, Belmont, MA (US); Peter Lieberwirth, Carlisle, MA (US); Richard Salz, Georgetown, MA (US)

Correspondence Address: LUCASH, GESMER & UPDEGROVE, LLP, 40 BROAD ST, SUITE 300, BOSTON, MA, 02109, US

(21) Appl. No.: 09/840,472

(22) Filed: Apr. 23, 2001

(51) Int. Cl. H04L 9/00

(52) U.S. Cl. 713/180

(57) ABSTRACT

A digital signature system is provided on a server for use by remote clients, such as by using a browser. The server generates and maintains all of the users' keys used for producing a digital signature. A user sends a data object to the server, and the server generates a digital signature for the data object using the private key stored at the server. The server then sends the digital signature to the client. A client can, at a later time, send the signature back to the server for verification.

### BACKGROUND OF THE INVENTION

1. Field of the Invention

The present invention relates generally to methods and systems for authenticating data. More specifically, the invention relates to a method, apparatus and product for providing digital signatures on electronic documents and for authenticating the documents by verifying their signatures.

2. Background of the Invention

It is currently possible to create legally-binding documents using handwritten signatures and by notarizing the handwritten signature, if required. A handwritten signature provides a level of assurance that the written document was executed by person identified by the signature, and prevents repudiation of the signed instrument by the signer.

Computer-based methods of producing documents are becoming more prevalent. Electronic documents are replacing written contracts, orders, payment instruments, account statements, invoices, and other documents that have historically been signed by a written signature. It is frequently advantageous to have a document that has been produced and is being stored in digital form to have a digital signature applied to it so that the authentication of the signer can later be verified. The digitally-signed electronic document can then be transmitted for processing, without the need for a signed paper instrument.

A need has arisen for alternative mechanisms for creating and authenticating legally binding electronic documents and communications. Digital encryption, digital message digests, digital signatures, and digital certificates are some of the existing cryptographic tools that are used in the present invention to address this need.

Public key cryptography is used in some systems to provide such a digital authentication. Public key cryptography uses a two-key pair, typically referred to as a public key and a private key. These two keys appear to be completely independent, yet share an important property; data encrypted by the first can be recovered by the second, and vice versa. RSA is the most well-known public-key algorithm.

If one of the numbers is kept private and the other key is made available, then anyone can use the public key and encrypt a message so that only the intended recipient can read it. By encrypting with the private key, anyone can verify with the public key and be assured that only the private key-holder performed a specific operation, thus providing a non-repudiation function.

Public-key encryption is computationally expensive. However, when public-key encryption is combined with hashing, a powerful digital signature becomes possible. Hashing involves taking an arbitrary stream of bytes and processing it down to a small number of bytes called the hash. The processing is such that no two streams will result in the same hash. There are a number of hashing algorithms, including MD5, SHA-1, SHA-256, and RIPE-MD 160. A digital signature can be produced by the following algorithm:

1. Take an arbitrary set of data of any size;

2. Hash the data;

3. Encrypt the hash with X's private key; this is X's signature on the data.

To verify the signature:

1. Take the same set of data;

2. Hash the data using the same algorithm;

3. Decrypt the sender's hash with their public key;

4. If the two hashes are the same, the signature is valid.

An XML digital signature object is currently provided in XML systems. Bytes of data to be signed are collected into a digital document, and a digital signature is created over the data content. The data content is transformed before it is signed. A “reference” is created that names the content, identifies data transformation and hashing algorithms, and includes the hash. To produce the XML-digital signature, the references are hashed, and this hash is signed.

The XML data structure for digital signatures contains the following elements:

Signature

SignedInfo—reference to the content being signed

SignatureValue—the actual signature, which is a signed hash of the SignedInfo data block

KeyInfo—identifies the signer and his key

SignedInfo Reference

Name of the content

Name of data transformation to be performed

Type of hashing to perform

Hash Value

According to current XML data structures, the Signature element has a SignedInfo element within it. The hash of the SignedInfo element is what is actually signed. The SignedInfo element includes one or more Reference elements. Each Reference element contains the hash of the content, the URI and information on the hashing algorithm that was used for the hash. The XML digital signature recommendation processing rules require that in order to verify a signature, each Reference hash must be validated, and the signature over the SignedInfo element must be validated.

Using current digital signature systems, a client computer is connected over a network to a server computer. The client must generate a signature using cryptographic hardware and/or software. The client conveys the signature and optionally its public key to the intended recipient. Using current systems, the client system must have much of the functionality of the digital signature system, and the client must generate the encryption keys.

It is therefore an object of the present invention to provide a digital signature system that has all of its functionality on a server, including generation and maintenance of client keys.

It is a further object of the present invention to provide a digital signature system that allows a remote client to send a data object to the server, and the server generates a digital signature on the data object and returns the signature to the client.

It is an additional object of the invention to provide a digital signature system that verifies signatures that it previously produced on a data object upon request from a client.

It is also an object of the present invention to allow the content being signed to be “split” across the two parties, so that the compromise of one does not result in the generation of unintended signatures.

### SUMMARY OF THE INVENTION

These and other objects are attained by the invention, one aspect of which comprises a signing server that creates a signature for a data object, associates the signature and the data object with a signed object, and later authenticates the signed object. According to the invention, the client computer accesses the signing server, such as by using a browser, and then transmits the data object from the client to the server via a communications channel such as the Internet. Upon receiving the object, the server processes the object to generate a signature, associates the signature with the object to generate a signed object, and transmits the signed object back to the client.

Subsequently, upon a request from the client, the server authenticates the signed object by deriving the original data object and the signature from information obtained from the signed object sent by the client. The server then generates a comparison value by hashing the original data object to produce a second hash, and comparing the hash value in the signature to the second hash. The server also checks the hash value in the signature using the user's public key. If the document is authenticated, the server notifies the client that the authentication was successful.

According to the invention, the server generates and manages the clients' keys that are used to generate a signature. In the preferred embodiment, the server authenticates the client upon request and then assigns a private key to the client. The client can then send a data object to the server to be signed. The server creates a signature for a specific client by performing a hash function on the data object to produce a hash total, and then performing an encyphering process on the hash total using the client's private key.

A signed object can have a detached signature, an enveloped signature, an enveloping signature, or a signature with the hash of the data object. When the signed object has a detached signature, the signed object is actually a new, second object, that contains the signature and the address of the signed object. When the signed object has an enveloped signature, a new object is also created that contains the original object and the signature. When the signed object has an enveloping signature, the signature is placed within the original object, which becomes the signed object.

According to one embodiment of the invention, when the server creates a signed object, it assigns a signature field and a signature property field to the signed object. The signature field contains the signature that is generated by the server. The signature property field contains a timestamp, a client identifier, key information, or other data that is signed by a key generated and maintained by the server.

When the client subsequently requests verification of a signed object, the server obtains the data object and the signature from information in the signed object. The server authenticates the object by verifying the original signature, which is obtained from the signature field of the object. The server generates a second hash using the original data object and the data in the signature property field, and compares the hash from the signature with the second hash. If the hash values match, the server generates a “valid” verification response, which it sends to the client. Alternatively, the server can create a signature on the verification response, creating a signed verification receipt.

Many other implementations of the present invention are available according to the present invention, as will be seen by the following description of the invention.

### BRIEF DESCRIPTION OF THE DRAWINGS

FIG. 1 shows the system configuration of the present invention, including a signing server connected to a client over the Internet.

FIG. 2 shows a Signing Request and a Signing Response as implemented in the configuration shown in FIG. 1.

FIG. 3 shows a Verification Request and a Verification Response as implemented in the configuration shown in FIG. 1.

FIG. 4 illustrates how the server generates and assigns private keys to three connected clients.

FIG. 5 shows a method the server uses to pick a private key to generate a signature for an object shown in greater detail.

FIG. 6 illustrates server's generation of a signature for a data object.

FIG. 7 shows how a signature can also be generated using the hash of the object, the private key, and the server key.

FIG. 8A illustrates the generation of a signature for a data object, creating a signed object.

FIG. 8B shows the signed object having a detached signature.

FIG. 8C shows the signed object having an enveloped signature.

FIG. 8D shows the signed object having an enveloping signature.

FIG. 8E shows the signed object having a hash of the data object stored in the signature.

### DETAILED DESCRIPTION OF THE INVENTION

The present invention is a server-side digital signature system. According to the invention, a client sends a data object, or document, along with a signing request to the server. The server, using the client's key stored on the server, generates a signature for the data object, creates a signed object, and returns the signed object to the client. The client can subsequently send a verification request, along with the signed object, to the server. The server verifies the signature by generating a new hash using the original data and the client's private key, and comparing the new hash to the hash derived from the signature that was assigned to the signed object. All of the functionality of the digital signature system is performed by the server, including creating, storing, controlling and managing the clients' signings keys, other encryption keys and the hash functions used by the system.

Various types of clients can access the server-side digital signature system of the present invention. For example, a user-interface based application can allow individuals to sign documents. An enterprise application could use the signing server to sign transactions. Document management or workflow frameworks can call out to the signing server to sign documents. Other basic user applications, including Java-based applications and browser-based user interfaces, as well as interfaces to allow integration with enterprise applications or document management frameworks are possible, as will be apparent to those familiar with the art.

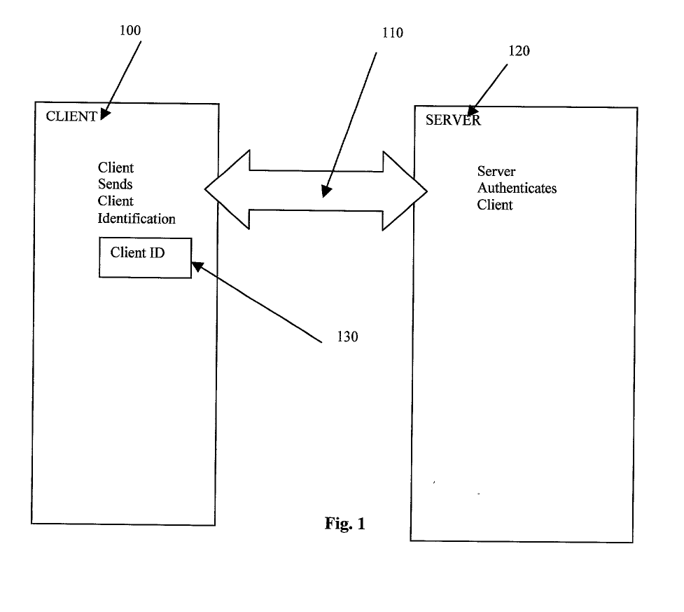

Referring to FIG. 1, a client 100 connects to the server 120 over a communication channel such as the Internet 110. The client 100 must first authenticate itself with the signing server 120 of the present invention, and send a user or client ID 130 to the server over the communications channel. According to the present invention, the server requires authentication of all signers and verifiers in order to use its signing services. Signers and verifiers using the system are registered on the server using the Secure Sockets Layer (SSL). The default authentication is the name/password combination secured by SSL, however, in alternate embodiments, other authentication systems may be used. Client-side certificates are an authentication option. All signing and verification operations are logged at the server.

The client can authenticate to the server using one of several methods. The client sends information representing its identity to the server using either a password, an encrypted data channel, a public key-based processing step, or by presenting a client certificate. The client and server can mutually authenticate using a zero-knowledge proof algorithm. After the server has authenticated the identity of the client, the server assigns a private key to the client. The particular signing key to be used by the server is specified using the user/client ID that is passed to the server by the client. In the preferred embodiment, the e-mail address of the user is used to identify the user, and is named within the Client ID 130.

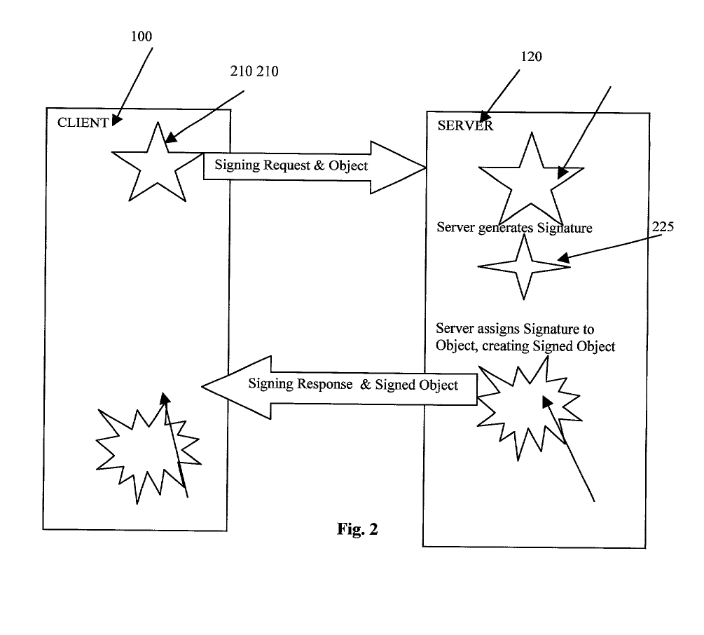

FIG. 2 shows a Signing Request and a Signing Response according to the present invention. A client 100 sends a Signing Request and a data object 210 to a server 120 over a connection such as the Internet. The server 120 processes the object and generates a signature 225 and assigns it to the object, creating a signed object 230. The server then 1 returns a Signing Response and the signed object to the client 100. The Signing Response includes “Success” or “Failure”, indicating whether the signature was successfully generated.

A signed object can have a detached signature, an enveloped signature, an enveloping signature, or a signature containing the hash of the data object. When the signed object has a detached signature, the server creates a signed object that contains the signature and the address of the data object. When the signed object has an enveloped signature, the server creates a signed object that contains the data object and the signature. When the signed object has an enveloping signature, the server writes the signature within the original data object, which then becomes the signed object. A signed object can also contain the hash of the data object contained within the signature.

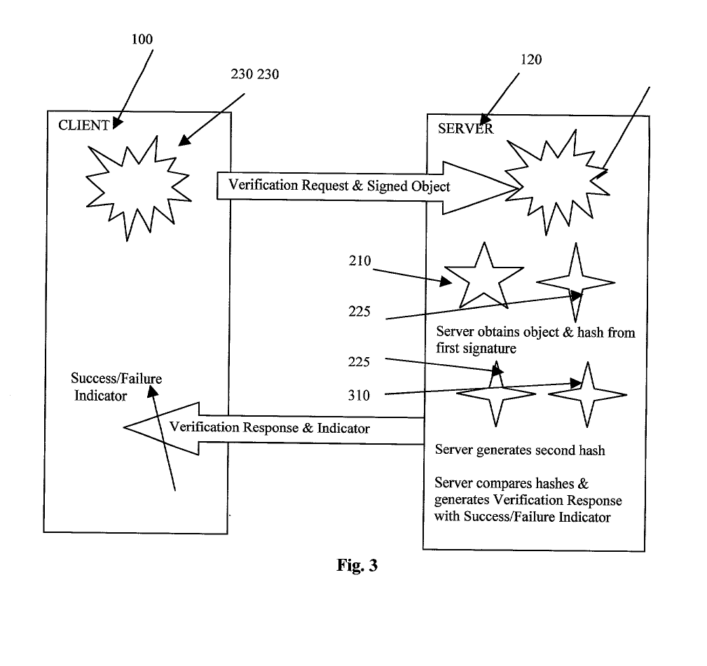

FIG. 3 shows a Verification Request and a Verification Response according to the present invention. Client 100 can later send the signed object 230 to the server 120 for verification. The server verifies the signature by obtaining the data object 210 and the hash from the first signature 225 from the signed object. The server generates a second hash 310 using the data object and compares the hash from the first signature 225 with the second hash 310. If the signatures match, the signature is valid. The server returns an indicator 320 showing the status of the signature, either valid or invalid.

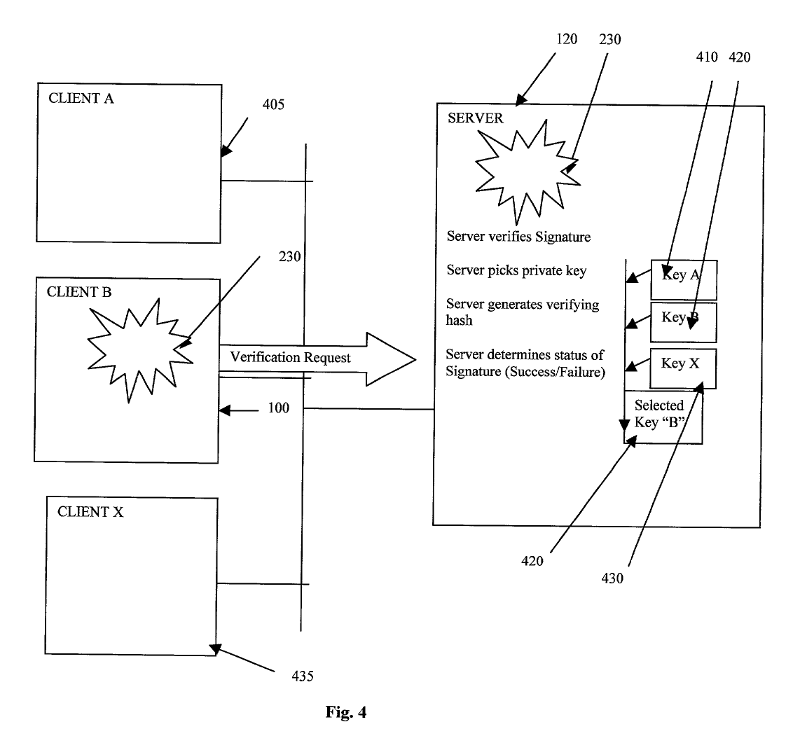

Referring to FIG. 4, client A 405, client B 100 and client X 435 are all clients using the digital signing server 120. The server 120 generates and assigns private keys to all of its clients, and as shown in this example, has generated and maintains private keys 410, 420, 430. When client 100 sends a signed object 230 to server 120 for verification, the server 120 determines, based on a specified system policy, available data or a specified algorithm, which private key 420 to use to generate a verifying hash. In the preferred embodiment, the particular signing key to be used is specified using the user email name, or Client ID 130 that was shown in FIG. 1. The client ID, or identification element, was passed to the server by the client upon authentication, as shown in FIG. 1. In alternate embodiments, the key may be specified using an issuer name and serial number, a key identifier, or by other techniques. The identification element is discussed in more detail below.

Referring to FIG. 5, the method to pick a private key to generate a signature for an object is shown in greater detail. The server uses the client ID 130, and other data 510 to select a private key from the keys 410, 420, 430 that are stored on the server. The server picks a key to use at 520, and generates a signature for object 210 by hashing the object and then encrypting the hash. The signature is stored with the object 210 in a new object, the signed object 230.

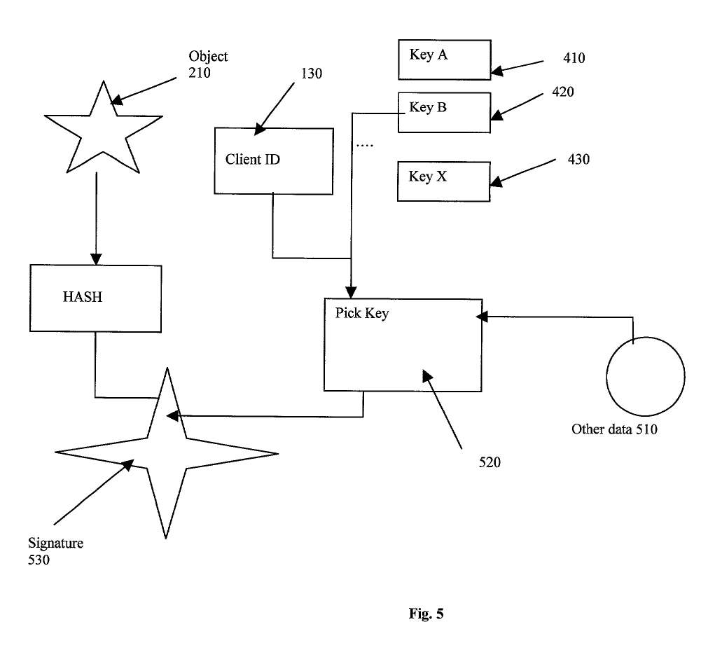

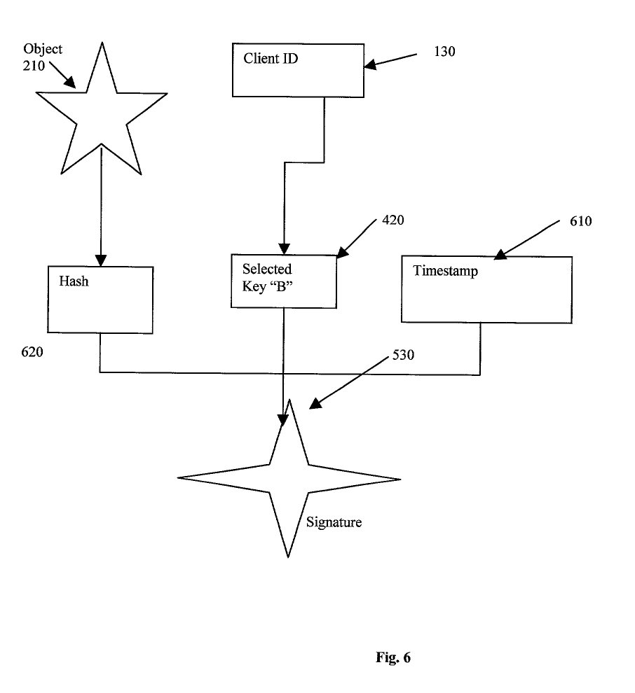

As shown in FIG. 6, the system generates a signature of a data object 210. Object 210 is hashed, according to a predetermined hash function 620. The client ID is determined by the server, and is used by the server to select a key 420. The server also produces a timestamp, and generates a signature 530 using the hash, the chosen key, and the timestamp. These functions are described in more detail below.

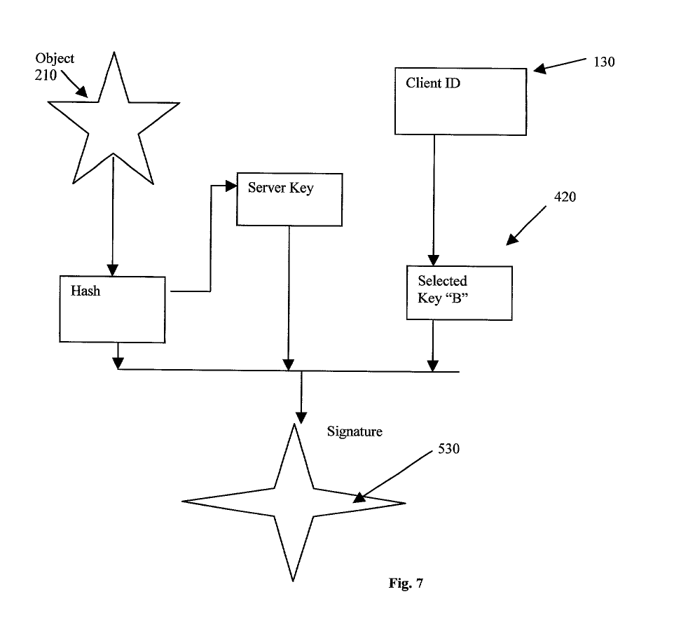

As shown in FIG. 7, the signature 530 can also be generated using the hash of the object, the private key, and the server key, and that signature is incorporated into a signature 530 for the client.

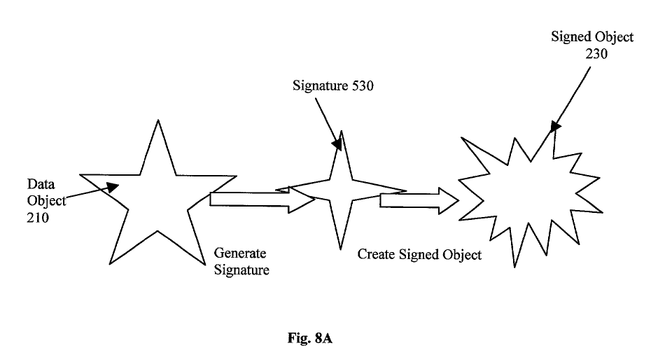

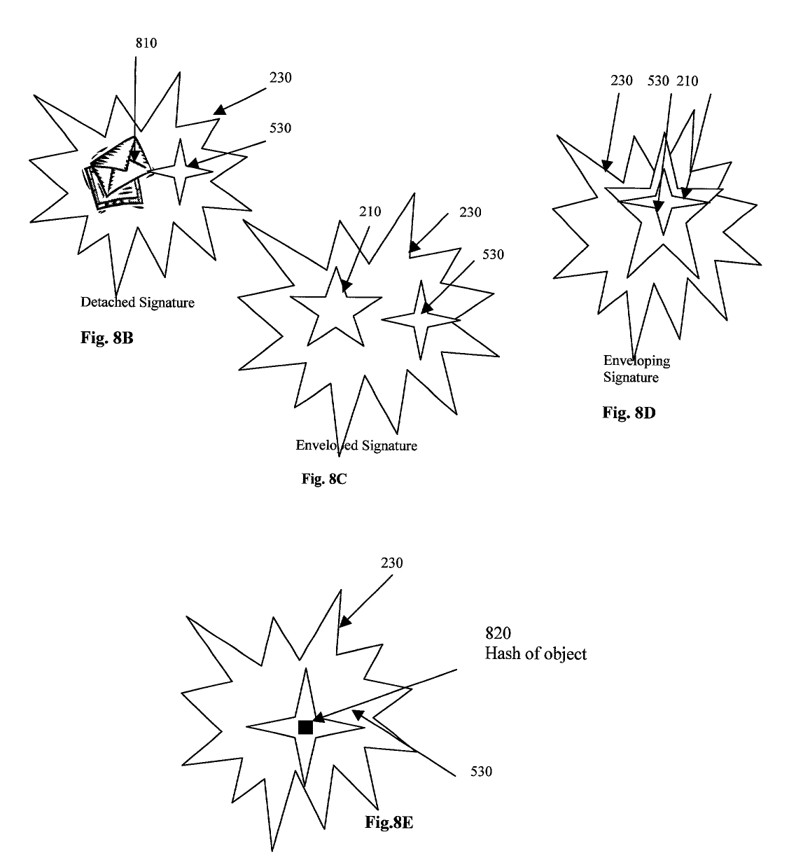

As shown in FIG. 8A, the system generates a signature 530 for data object 210, creating signed object 230. As shown in FIG. 8B, the signature can be detached. In this case, the signed object 230 contains the address of the data object 810 and the signature 530. FIG. 8C shows an enveloped signature. Here, the signed object 230 contains the data object 210 itself and the signature 530. FIG. 8D shows an enveloping signature, where the signature 530 is placed within the original data object 210, which becomes the signed object 230. As shown in FIG. 8E, a hash 820 of the data object 210 can be stored in the signature 530, which becomes the signed object 230. A hash of the object is stored in the signature when the client requests that only the signature be returned.

### DESCRIPTION OF A PREFERRED EMBODIMENT

In the preferred embodiment of the present invention, the system is implemented using a modification of the standard XML Digital Signature Recommendation, although many other implementations are possible. The modified XML structure will be referred to as a Hancock XML in this specification, and will be used to illustrate a particular embodiment of the invention. Appendices A through S show examples of specific Hancock XML code implementing the preferred embodiment.

Client requests to the server and the server's responses to the clients are XML documents. This allows a variety of possible interfaces to the present invention, including a HTML form interface with a CGI backend that produces the XML requests, a client that generates an XML request and transmits the request to the server using the SOAP application protocol over HTTP, and a client interface that reads XML requests from files.

According to the present invention, the standard XML Object element has an additional element, named the HancockSignatureProperties element. In addition, the Server-Side digital signature provides signature attributes that are unique to the present invention. The HancockSignatureProperty element is always part of the Hancock signature, and ensures the integrity of the Hancock signature properties. The HancockSignatureProperty element is always included in the Signature element.

According to the present invention, requests and responses are XML documents. The system provides Signing Requests, unsigned Verification Responses and signed Verification Receipts. The only signature on a Signing Request and a Verification Response is the requested signature on the document. A signed Verification response is a verification response that has been signed for the relying party, the party who requested the verification.

Hancock XML elements are defined within the Hancock namespace. For example, a signing request would be: xmlns=“urn:caveosystems:sign1”. A verification request would be: xmlns=“urn:caveosystems:verify1”.

Signing Request

Appendix A shows an example of a Hancock XML SigningRequest element that is sent from a client to the server. According to the preferred embodiment, a Hancock SigningRequest is an XML document that includes a document element, a signing policy and an indication of how the result is to be returned. The document element specifies the document to be signed, either by including the data itself or the address of the data. An address is specified by using the URI element. If the document element contains actual data, the data may be base64 encoded. This is specified with the Algorithm attribute of the Document element.

The SignaturePolicy element is used to specify how the signing is to be performed. This includes the type of signing, the signing key to use, the required cryptographic strength required for the signature, the formatting of the signature, whether or not to include the <keyinfo>element, and a SSDSSignatureProperties element. The signature policy also indicates whether the signer can countersign, whether the timestamp should be secure, whether a manifest will be used to include the references to the signed documents. In alternate embodiments, one or more of these parameters may be used, giving a different combination of signing policy attributes possible. For example, the Policy element can also be used to specify document canonicalization and transform requirements.

As shown in Appendix A, the client is requesting detached signing and that only the new signature is to be returned in the response. The signing key to use is specified using the KeyName element within the KeyInfo element. The KeyNameType indicates that the key for this client is associated with the e-mail address of the user. The key can also be specified using an X509Data element, by defined the XML Digital Signature recommendation. The key can also be specified using an issuer name and serial number, a key identifier, or by other techniques.

The SigningRequest allows the client to specify how much of the signer's certificate chain to include. In this case, “All” indicates to use all of the certificate chain. The Type attribute is optional and specifies how to represent certificates in the certificate chain. Defining the Type attribute as “Certificate” indicates that the actual certificate is to be used, and is base64 encoded. An alternative, such as certificate hashes or identifiers may be specified. All certificates in the chain are represented in the same manner.

The SigningRequest specifies how the response is to be returned using the Return attribute. In Appendix A, Return—“Signature”, indicates that only the signature is to be returned in the signed object. The client could also request that the entire data object or the URI address of the data object be returned in the signed object.

In the code shown in Appendix A, the Document URI is specified as the url of the data object. The client is therefore specifying which data object to sign using the address of the data object document. The Document Element may specify more than one document to be signed if a signature is to be produced over several documents.

Appendix B is example code showing a SigningRequest where the actual document is included in the request. The user has specified receiving an enveloped signature. The private key to be used is specified by the issuer and the serial number of the associated public key certificate. No Return attribute is specified, so the default Return=“Signature” will be used.

Appendix C shows a sample purchase order document to be signed. This document is produced at the client, and the client will send it to the server to be signed by including it in a SigningRequest.

Appendix D shows the purchase order of Appendix C included in a SigningRequest. The data to be signed is included in the body of the request, and the signature is to be enveloped. The key to be used is specified using the user's e-mail address.

An end-user can define user-specific properties using the UserProperties element in the SigningRequest. The UserProperties element is inside an Object element in the Signature element, and a reference to the UserProperties is included in SignedInfo. This is discussed in more detail below.

Signing Response

Referring again to FIG. 2, when a signing request is sent to the server, the server creates a SigningResponse element. The SigningResponse element includes a Status element having a Type attribute of “Success” or “Failure”, and additional information regarding the status may be sent within the SigningResponse element.

Appendix E shows code representing the enveloped signed object that results from generating a signature over the SigningRequest of Appendix D. The data itself is returned in the signed object, as an enveloped signature was requested.

Appendix F shows the code representing the enveloped signed object of Appendix E in a SigningResponse element. The data object has been signed with an enveloped signature, and the SigningResponse is a signed object containing the actual data and the signature. The signing was successful, as indicated by the Status Type.

The SigningResponse includes either the signature document itself or a URL specifying how to obtain the signature document. Specifying a URL is useful when the enveloped signature document is large. In one embodiment of the present invention, the server-side digital signature system also provides storage for documents whose signatures are not needed immediately. Storage of the document is requested by specifying the URL as the value of the SignatureDocument attribute of the SigningResponse element.

The SigningResponse element returns either the entire signature document, the signature element, or a URI for the signature document depending on the Return SigningRequest attribute. The SignatureResult element Return attribute specifies the type of return, and should always match the request. The present invention passes the signature document as the content of the SignatureDocument element within the SigningResponse.

Verification Request

Referring again to FIG. 3, the client can also send a Verification Request, requesting either an unsigned verification response or a signed verification receipt, to the server. The server performs verification of a signed object and sends a response back to the client. Documents to be verified may be specified by URL or by uploading the document content from the client to the server. The URL of a document to be verified does not need to match the URL specified in the document signature reference, but the hash of the document to be verified must match the hash of the document reference. When the verification request asks for an unsigned verification as a response, the server's response would be either “Invalid” or “Valid”. When the client asks for a signed Receipt, the server produces a signed verification response signed by requesting client.

An independent VerifyInfo element is used to specify each signature to verify. A single VerificationRequest may include one or more VerifyInfo elements. All of the VerifyInfo elements in each VerificationRequest must all be of the same type, either unsigned verification or receipt. Each VerifyInfo element must have a unique Id attribute for the request, if more than one is included in the request. Each VerifyInfo element must include the signature to be verified and the document information that is necessary for signature information.

A VerificationPolicy element is used to include options on the degree of credential checking required for verification, whether the VerificationResult document is signed at all, by the verifier, and or by the SSDS system. Options on the format of the VerificationResult document, including whether or not a SSDSSignatureProperties element is present is also specified in the VerificationPolicy element.

The signature to be verified can be either the signature element in a detached signature document, or can be the signature from an enveloped signature within an XML document. The signature can be a signature element with the Id attribute, but no content, if the verification server archived the original signature with that Id.

The document information that is necessary for signature verification may be one of the following: 1) the actual document contained within a Document element; 2) a document identifier contained within a DocumentIdentifier element; or 3) a document URL, suitable for fetching the document. If none of this document information is provided, then the document hash contained within the signature is used as the document information. When the actual document is contained within a Document element, the data is base64 encoded if the Algorithm attribute is specified and has a type corresponding to base64 encoding.

Appendix G shows the code format of a VerificationRequest using the entire document. The verification request indicates what type of request is being asked for, either response or receipt, by setting the Type attribute to either “response” or “receipt”. The XML signature to be verified is included, along with the address of the data object, which is base64 encoded.

Appendix H shows an example of code for a VerificationRequest using just a signature identifier and document URL. This type of VerificationRequest is used when the server archived the original signature with the Signature ID. The signature is verified over the data object specified by the document URL. If the document URL were not specified, the DocumentHash element would be used to create the document reference.

When the Document element content is present, then the signature is verified using the data content in the request. If the Algorithm attribute is specified, such as base64 encoding as shown in Appendix G, then the element content is decoded according to the specified algorithm. If the Algorithm attribute is not specified, the element content is not specified. If the Document element is empty, then a URI attribute is required and is used to fetch the document. If both the Document element and the URI element are present, then the element content is used to verify the signature and the URI is required to match the reference URI. If the Document element is not present, then the DocumentHash element is required and specifies the hash of the document used to create the document reference. The KeyInfo element of the signature is used to specify the certificate and the public key used to verify the signature.

Verification Response

Appendix I is an example of code for a VerificationResponse according to the present invention is shown. The verification response indicates the result of verifying the signature as requested by the VerificationRequest shown in Appendix H. As shown in the code in Appendix I, the SignatureStatus was “Invalid” and the CredentialStatus is “Revoked”. The VerificationResponse also includes a Server Identifier and a Timestamp.

The VerificationResponse is an XML element that includes a VerifyInfo element corresponding to each VerifyInfo element in the VerificationRequest. If more than one VerifyInfo element is in the response, then each is required to have an Id attribute with the value matching that of the corresponding VerifyInfo element in the VerificationRequest. The verification response does not include the signature specifications because the requestor obtained the signature specifications when a verification request was made.

The VerifyInfo element may include a SignatureReference element with a Type attribute specifying one of the following types of references:

1. The hash type has a value containing the encoded hash of the Signature element, where the hash that was encoded according the specified algorithm.

2. The id type has a value containing the Id attribute of the Signature element.

3. The opaque type has an opaque value which the Hancock verifier can use to look up the signature.

The SignatureStatus element in the VerificationResponse summarizes the result of signature verification, “Valid”, “Invalid”, or an error message. Each VerificationResponse includes a Timestamp element and a SignatureReference element. The Timestamp element and the SignatureReference element are defined the same way that they were for the SignatureProperties element. In one embodiment of the present invention, the server-side digital signature system provides signature verification using the SignatureStatus element. In an alternate embodiment, the server-side digital signature system provides signature verification using the CredentialStatus element.

Verification Receipt

A Verification Receipt is a Verification Response that is signed at the server by the Requesting Party. A Verification Receipt allows the Requesting Party to prove to a third party, such as an original signer or an escrow agent, that the Requesting Party performed due diligence by verifying the signature at a specific point in time. The sequence of events for a verification receipt is as follows:

1) Relying party requests signature verification.

2) Relying party receives verification response.

3) Relying party submits verification response for signing.

4) Digital signature signing server produces signed verification response.

Appendix J contains code of an example VerificationResponse that is a Verification Receipt according to the present invention, as shown by the “TYPE=‘receipt’” field. A VerificationResponse that is a Verification Receipt has one or more additional Signature elements containing the appropriate signatures. The SignatureProperties element in the Signature element is used to distinguish the signatures.

Signature Summary Request

A signature summary document is an XML document that provides information about one or more signatures, including information such as the signature algorithm, key strength and rating, the availability of associated credentials and credential information, signature property information, and an indication of what portion of the document is included in the signature.

Appendices K and L each contain examples of code for a SignatureSummaryRequest element. A SignatureSummaryRequest element specifies which signatures to summarize, either by specifying a detached signature document or by specifying a document that contains enveloped or enveloping signatures and optionally specifying the signatures within the document. The request includes Document Information and a Signature specification. The Document Information is identical to the Document Identification that is specified for a Verification Request. If a document hash is provided, the server-side digital signature system retrieves the document based on the hash. The Signature specification contains the Ids of the signatures to be summarized. If no signature specification is included, all of the signatures are summarized. This is specified by one or more SignatureIdentification elements, with the Id attribute.

Signature Summary Response

The SignatureSummary element includes a SignatureInfo element for each signature summary. It also always includes a Disclaimer element regarding use and warranty. A SignatureSummary may be an unsigned response, or a signed receipt, as indicated by the optional TYPE attribute.

Appendix M shows example code for a SignatureSummary. There is a SignatureInfo element for each signature in the signature document. Each SignatureInfo element provides information about that signature, including ratings of algorithms, keys and credentials. Ratings are from F− for worst to A+ for best, with +, − or no modifier for each letter. Each algorithm includes the algorithm identifier. Signer names and other information are also provided when available. The document can also include a legal disclaimer, such as “not responsible for use, or warranty”.

If the SignatureSummary contains more than one SignatureInfo element, then each SignatureInfo element has an Id attribute with the same value as the corresponding Signature element. Each SignatureInfo element has a Type attribute specifying whether the corresponding signature is “detached”, “enveloped” or “enveloping”. Each SignatureInfo includes a KeySummary element, a CredentialSummary element, and a SigSummary element, containing information about the signing key, associated credentials and signature respectively.

User-Defined Properties

End-users can define the properties that they wish to have signed using a modified XML document. The XML content is enclosed in the UserProperties element and is included in the signing request. The UserProperties element is inside the Object element in the Signature element. A reference to the UserProperties element is included in the SignedInfo element, including the user properties in the signature value. In the preferred embodiment, this is used to implement notarization services, to support user CSSD data, and to support other user-defined requirements.

The HancockSignatureProperty element contains the following components: a Hancock Timestamp, a Hancock ServerIdentifier, a Hancock SignatureReference and a Verification URI. The Hancock Timestamp indicates the time of signing at the Hancock server, which is provided using the local time of the server. The timestamp is used to sequence events at the server, and is contained within the Timestamp element. The Hancock ServerIdentifier is used to identify the particular Hancock server that produced the signature. This component is contained within the ServerIdentifier element. The Hancock SignatureReference correlates the signature with the log files and other records of a specific Hancock server. This and the Hancock ServerIdentifier provide a unique id for the signature, and is contained within the SignatureReference element. The VerificationURI identifies the default verification server. In an alternate embodiment, this identifier is used to specify an alternate server. The Verification URI is configurable in each Hancock server, and is contained within the Verification URI element.

The Hancock SignatureProperty element contains an AuthenticityStamp/License component that is used to prevent non-authorized users from creating a Hancock SignatureProperties element. The AuthenticityStamp/License provides verification that the particular digital signing server is licensed. The stamp is created in one embodiment by creating a hash of the Hancock Timestamp, Identifier and Reference String and a confidential phrase.

Signature Elements

Appendix N shows an example of code for a Hancock XML Signature element. Items in parentheses are optional. Each Reference element contains fields for a URI, a Transform, a DigestMethod, and a DigestValue. The URI is an address of the data object to be signed. The Signature element has an Object for each property desired.

When a signature is detached, it is contained in a document separate from the document that contains the data. In an XML system, when the signature is detached, a signature document contains the XML signature element and a pointer to the second independent document. The second document contains the signed data content. An enveloped signature is contained in the same document with the data. When the signature is enveloped, a new document is created that contains the XML signature element as well as the data content. One method of creating an enveloped signature is to add the signature element to the document is in a different namespace from the original document. A second method of creating an enveloped signature is to place the data content as an object inside the signature element.

Appendix O is code showing the structure of the Reference element of Appendix N in more detail. The URI refers to an external document when a detached signature is requested. Hancock uses fully-specified URL's, except when there is an enveloped signature reference or when there is a reference to the Hancock Signature Object. The URI refers to an enclosing root XML document for an enveloped signature, and it refers to an XML fragment for a signed signature property. Transforms, DigestMethod, and DigestValue provide the information needed to obtain the hash of the data content, and the actual hash of the data content.

Appendix P is code showing an example of the KeyInfo element of Appendix N. In the code shown in Appendix P, a certificate chain is provided that includes an X508Data element. The KeyInfo element contains key information needed by the verifier to verify a signature. A certificate chain can be provided; in this case, the certificate chain is used to validate the public key associated with the signature. A KeyName can also be provided to look up the key at the server. An identifier can also be provided in this field.

Appendix Q is code showing the Object element of Appendix N in more detail. The Object element defines other signature properties. The Signature element has an Object for each property desired.

Appendix R is code for an example of the reference for the ServerSignatureProperties. The HancockSignatureProperties element is specific to the present invention. Properties to be signed must have a unique ID. In this example, the ID is the ServerSignatureProperties ID. The signed info element in the Signature element must include a reference for the property. The URI is a fragment for the ID, and in this example, it would be a URI value of #ServerSignatureProperties. The SignatureProperty element has a unique ID so that it can be referenced from the Reference element. This allows the VerificationResponse elements to refer to multiple signatures. Hancock generates and assigns an ID to each Signature. The ID is used to match the verification response to the signature.

Algorithms are specified using the URI's defined in the XML Digital Signature specification. One embodiment of the present invention uses the RSA-SHA1 algorithm, although other algorithms are well-known in the art.

The XML KeyInfo element is supported in the Hancock system. Hancock signatures are self-contained and are complete. In one embodiment of the present invention, the Hancock KeyInfo element contains the public key X.509 certificate, and in another embodiment, contains the entire certificate chain.

In the preferred embodiment, the Hancock system has a X509Data element with an X509Certificate element for each certification in the chain. Each certificate is a base64 encoded X.509 certificate. In an alternate embodiment, the KeyName element within the KeyInfo element allows the key information to be kept private at the server for validation. The preferred embodiment uses base64 encoding and decoding, SHA-1 digest, and RSA with SHA-1 Signature.

All elements that are specific to the server-side digital signature system of the present invention, namely the HancockSignatureProperties element, the Hancock-specific requests and the Hancock-specific responses, are contained in the Hancock namespace.

Application Protocol

In the preferred embodiment of the present invention, Signing Requests, Signing Responses, Verification Requests and Verification Responses are transported using the SOAP application protocol, allowing remote procedure calls. SOAP defines a wrapper to go around the requests and responses, allowing for routing and processing. One advantage of SOAP, an XML based protocol, is that it is transported over HTTP, allowing access through most firewalls.

In other embodiments, the requests and responses according to the present invention are transported by other mechanisms, and can also be archived. For this reason, the request and response names are unique to distinguish them without relying on the transport wrapper. Where XML uses only a Signing element, the present invention provides SigningRequest and SigningResponse elements instead. The SigningResponse element can be wrapped in a SOAP envelope. The SOAP wrapper can also convey failure information.

Appendix S is an example of SOAP code showing a Hancock SigningRequest enclosed in a SOAP wrapper. The Internet host is specified as www.signingserver.com, and the content type is specified as XML.

Integration with Existing PKI Systems

According to the present invention, the server-side digital signature system can be integrated with an existing Public Key Infrastructure (PKI) system. In this configuration, the end-entity has a public/private keypair and a public key certificate. The key pair may have been generated using any of a number of possible methods. The private key may be held on the end entity's computer, or it may be in a hardware token. The present invention does not use the private key generated by the existing PKI to generate signatures, but instead uses a private key it creates on behalf of a signer to generate signatures for that signer.

The server-side digital signature system of present invention can load an externally generated private key via its core encryption engine. In alternate embodiments, this mode of operation is used to support various signing scenarios. The PKI generated private key can optionally be used to authenticate to the server-side signature generator for purposes of signing, verification, or administration.

The PKI-generated private key can also be used to support two-factor content. Two-factor content provides an additional level of non-repudiation support for any server-generated signature utilizing it. In one embodiment of the present invention, private keys that have not been generated by the server-signer can be used for signatures.

Alternate embodiments provide a number of methods for end-entity private signing key management. One method is to upload the end-entity private key to the server. A second method is to use only signatures generated using some form of two-factor content. According to a third method, the server provides some low-level interfaces to the client, such as a hash function or a function to create an XML signature document given a signature and a key.

While the invention has been described in a particular XML implementation, it will be apparent to those skilled in the art that many other implementations are possible.

[image]

[image]

[image]

[image]

[image]

[image]

[image]

[image]

[image]

[image]

We claim:

1. In a processing system including a server capable of communicating with a client via a communications channel, a method of authenticating a data object, the method comprising the steps of, in the server,
(1) receiving the data object transmitted from the client to the server via the communications channel;
(2) generating a signature by processing the data object;
(3) associating the signature with the data object to create a signed object; and
(4) authenticating the signed object, subsequently upon request, by:
(a) deriving from the signed object information representative of the data object and the signature,
(b) generating a comparison value using the information representative of the data object,
(c) determining whether the comparison value and at least a portion of the signature meet a pre-determined criteria.

2. The method of claim 1 wherein the data object comprises a document.

3. The method of claim 1 including the further step of, in the server, authenticating the client.

4. The method of claim 3 wherein the client is authenticated by the server using information representative of the client.

5. The method of claim 4 wherein the information representative of the client comprises a password provided by the client.

6. The method of claim 3 wherein the client is authenticated by the server using an encrypted data channel.

7. The method of claim 6 wherein the encrypted data channel utilizes a SSL protocol.

8. The method of claim 3 wherein the client is authenticated by the server using a public key-based processing step.

9. The method of claim 8 wherein the public key-based processing step includes the presentment of a client certificate.

10. The method of claim 9 wherein the client and server mutually authenticate using a zero-knowledge proof step.

11. The method of claim 3 including the further step of, in the server, creating and managing private keys to use in the step of generating the signature.

12. The method of claim 11 wherein the server assigns a private key to the client.

13. The method of claim 12 wherein the private key assigned to the client is determined based upon the information representative of the client.

14. The method of claim 13 wherein the step of generating the signature includes the steps of:
assigning a private key to the client;
performing a predefined hash function on the data object to produce a hash total; and
encyphering the hash total using the private key.

15. The method of claim 1 wherein the signed object comprises the signature and an address of the data object.

16. The system of claim 1 wherein the signed object comprises the signature and the data object.

17. In a processing system comprising a server capable of communicating with a client via a communications channel, a method of generating a digital signature, the method comprising the steps of, in the server:
receiving a data object transmitted from the client to the server via the communications channel;
assigning to the data object a descriptor containing a property field, the property field containing a signature field;
assigning a private key, stored at the server, to the client;
processing the data object using a pre-determined hash function and the private key to generate a signature; and
attaching the signature to the signature field associated with the data object to create a signed object.

18. The method of claim 17 including the step of, in the server, authenticating the signed object by verifying the signature attached to the signature field of the signed object.

19. The method of claim 18 wherein the verifying step further comprises the steps of:
(a) obtaining the data object from the signed object;
(b) obtaining the signature from the signed object;
(c) obtaining the private key stored at the server used to generate the signature;
(d) processing the data object using a pre-determined hash function and the private key to generate a comparison value; and
(e) determining whether the comparison value and at least a portion of the signature meet a pre-determined criteria.

20. The method of claim 19 wherein the property field further comprises a timestamp.

21. The method of claim 20 wherein the property field further comprises an identifier used to look up a key stored at the server.

22. The method of claim 19 wherein the property field further comprises key information used to generate the comparison value.

23. The method of claim 17 wherein the descriptor further comprises a plurality of property fields.

24. The method of claim 23 wherein at least one of the property fields further comprises data that is private to the server.

25. The method of claim 23 wherein at least one of the property fields further comprises additional data that is signed by a key private to the server.

26. The method of claim 25 wherein the additional data is derived by processing the data object using a pre-determined function.

27. The method of claim 26 wherein the pre-determined function is a hash function.

28. The method of claim 26 wherein the pre-determined function is a transform function.

29. The method of claim 25 wherein the additional data is obtained from a device.

30. The method of claim 29 wherein the device receives the data object prior to subsequent processing by the server.

31. The method of claim 29 wherein the device does not receive the data object.

32. The method of claim 29 wherein the device further comprises a device for generating a timestamp.

33. The method of claim 29 wherein the additional data, after being obtained from the device, is used by the server to generate the signature.

34. A method of transmitting transaction objects between a client and a server capable of communicating with the client via a communications channel, the method comprising the steps of:
receiving at the client, from the server, an HTML object having a header record and an HTML form tag distinct from the header record, the HTML form tag having an outformat field representative of an outgoing transmission cryptographic protocol,
receiving, at the client, input form data corresponding to the HTML form tag, generating secure form data by applying the specified outgoing transmission security cryptographic protocol of the HTML form tag to the input form data, and transmitting to the server a return message including the secure form data.

35. A computer implemented method of providing a digital signature system on a server for use by a remote client, the method comprising:
generating on the server a private key for a user on the client;
storing on the server the private key for the user;
generating a digital signature using the stored private key for a data object provided by the user; and
sending the digital signature to the client.

36. The method of claim 35 wherein the digital signature is contained within a signed object.

37. The method of claim 36 wherein generating the digital signature step further comprises:
performing a pre-defined hash function on the data object to create a hash value; and
performing a pre-defined encryption function using the private key on the hash value.

38. The method of claim 37 wherein the signed object comprises the digital signature and an address of the data object.

39. The method of claim 37 wherein the signed object comprises the digital signature and the data object.

40. The method of claim 37 wherein the signed object comprises the digital signature contained within the data object.

41. The method of claim 36 wherein the signed object comprises a hash of the data object contained within the digital signature.

42. The method of claim 37, further including, on the server:
verifying the digital signature upon request by the client.

43. The method of claim 42 wherein verifying the digital signature further comprises:
receiving the signed object from the client;
obtaining the data object using information contained within the signed object; obtaining the digital signature using information contained within the signed object;
obtaining the private key stored on the server using information contained within the signed object;
generating a comparison value using the data object;
verifying the digital signature if the comparison value and at least a portion of the digital signature meet a predetermined criteria.

44. The method of claim 43 wherein the signed object comprises the digital signature and an address of the data object.

45. The method of claim 43 wherein the signed object comprises the digital signature and the data object.

46. The method of claim 43 wherein the signed object comprises the digital signature contained within the data object.

47. The method of claim 43 wherein the signed object comprises a hash of the data object contained within the digital signature.

48. The method of claim 35 further comprising, authenticating a user, by the server, before providing access to the system.

49. The method of claim 48 wherein authenticating a user further comprises receiving a user ID and a password from the client.

50. The method of claim 49 further comprising assigning, by the server, a private key to the client based upon the user ID.

51. The method of claim 35 further comprising assigning, by the server, a private key to the client based upon a system policy and data obtained from the client.

52. The method of claim 50 wherein the digital signature further comprises:
a encrypted field; and
a timestamp,
wherein the server generates the encrypted field by hashing the data object according to a predefined hash function to create a hash, and encrypting the hash using the private key assigned to the user.

53. The method of claim 52 wherein the digital signature further comprises a server key.

54. The method of claim 43 further including generating a verification response at the server and transmitting the verification response to the client.

55. The method of claim 54 further including generating a verification signature for the verification response at the server and transmitting the verification signature to the client.

56. A digital signature system including:
a server capable of communicating with a client via a communications channel, and
means for authenticating a data object, further comprising:
(1) means for receiving the data object transmitted from the client to the server via the communications channel;
(2) means for generating a signature by processing the data object;
(3) means for associating the signature with the data object to create a signed object; and
(4) means for authenticating the signed object, subsequently upon request, by: (a) deriving from the signed object information representative of the data object and the signature,
(b) generating a comparison value using the information representative of the data object,
(c) determining whether the comparison value and at least a portion of the signature meet a pre-determined criteria.

57. The system of claim 56 wherein the data object comprises a document.

58. The system of claim 56 further comprising means for obtaining information representative of the client to authenticate the client.

59. The system of claim 58 further comprising means for creating and managing private keys used to generate the signature.

60. The system of claim 59 further comprising means for assigning a private key to the client.

61. The system of claim 60 wherein the private key is assigned to the client using the information representative of the client.

62. The system of claim 56 wherein the means for generating a signature further comprise:
assigning a private key to the client;
performing a predefined hash function on the data object to produce a hash total; and
encyphering the hash total using the private key.

63. The system of claim 56 wherein the signed object comprises the signature and an address of the data object.

64. The system of claim 56 wherein the signed object comprises the signature and the data object.

65. A processing system comprising:
a server capable of communicating with a client via a communications channel,
processing means in the server for generating a digital signature, further comprising:
means for receiving a data object transmitted from the client to the server via the communications channel;
means for assigning to the data object a descriptor containing a property field, the property field containing a signature field;
means for assigning a private key, stored at the server, to the client;
means for processing the data object using a pre-determined hash function and the private key to generate a signature; and
means for attaching the signature to the signature field associated with the data object to create a signed object.

66. The processing system of claim 65 further comprising means for authenticating the signed object.

67. The processing system of claim 66 wherein the means for authenticating the signed object is further comprised of means for verifying the signature attached to the signature field of the signed object.

68. The processing system of claim 67 wherein the means for verifying further comprises:
(a) means for obtaining the data object from the signed object;
(b) means for obtaining the signature from the signed object;
(c) means for obtaining the private key stored at the server used to generate the signature;
(d) means for processing the data object using a predetermined hash function and the private key to generate a comparison value; and
(e) means for determining whether the comparison value and at least a portion of the signature meet a predetermined criteria.

69. The processing system of claim 67 wherein the property field further comprises a timestamp.

70. The processing system of claim 67 wherein the property field further comprises an identifier used to look up a key stored at the server.

71. The processing system of claim 67 wherein the property field further comprises key information used to generate the comparison value.

72. The processing system of claim 67 wherein the descriptor further comprises a plurality of property fields.

73. The processing system of claim 72 wherein at least one of the property fields further comprises data that is private to the server.

74. The processing system of claim 72 wherein at least one of the property fields further comprises additional data that is signed by a key private to the server.

75. The processing system of claim 74 wherein the additional data is derived by processing the data object using a pre-determined function.

76. The processing system of claim 75 wherein the pre-determined function is a hash function.

77. The processing system of claim 75 wherein the pre-determined function is a transform function.

78. The processing system of claim 74 further comprising a device for providing the additional data.

79. The processing system of claim 74 wherein the device receives the data object prior to subsequent processing by the server.

80. The processing system of claim 74 wherein the device does not receive the data object.

81. The processing system of claim 74 wherein the device further comprises a device for generating a timestamp.

82. The processing system of claim 74 wherein the server generates the signature after obtaining the the timestamp from the device.

83. A digital signature system for use by a remote client, the system comprising:
a server computer;
processing means on the server for generating a private key for a user on the client;
storing means on the server for storing the private key for the user;
processing means for generating a digital signature using the stored private key for a data object provided by the user; and
transmitting means for sending the digital signature from the server to the client.

84. The digital signature system of claim 83 wherein the digital signature is contained within a signed object.

85. The digital signature system of claim 84 wherein the processing means for generating the digital signature further comprise:
means for performing a pre-defined hash function on the data object to create a hash value; and
means for performing a pre-defined encryption function using the private key on the hash value.

86. The digital signature system of claim 85 wherein the signed object comprises the digital signature and an address of the data object.

87. The digital signature system of claim 85 wherein the signed object comprises the digital signature and the data object.

88. The digital signature system of claim 85 wherein the signed object comprises the digital signature contained within the data object.

89. The digital signature system of claim 85 wherein the signed object comprises a hash of the data object contained within the digital signature.

90. The digital signature system of claim 85, further comprising:
verifying the digital signature upon request by the client.

91. The digital signature system of claim 90 wherein the means for verifying the digital signature further comprises:
means for receiving the signed object from the client;
means for obtaining the data object using information contained within the signed object;
means for obtaining the digital signature using information contained within the signed object;
means for obtaining the private key stored on the server using information contained within the signed object;
means for generating a comparison value using the data object;
means for verifying the digital signature if the comparison value and at least a portion of the digital signature meet a predetermined criteria.

92. The digital signature system of claim 91 wherein the signed object comprises the digital signature and an address of the data object.

93. The digital signature system of claim 91 wherein the signed object comprises the digital signature and the data object.

94. The digital signature system of claim 91 wherein the signed object comprises the digital signature contained within the data object.

95. The digital signature system of claim 91 wherein the signed object comprises a hash of the data object contained within the digital signature.

96. The digital signature system of claim 91 further comprising means for authenticating a user before providing access to the system.

97. The digital signature system of claim 96 wherein means for authenticating a user further comprises means for receiving a user ID and a password from the client.

98. The digital signature system of claim 97 wherein the server assigns a private key to the client based upon the user ID.

99. The digital signature system of claim 98 wherein the server assigns a private key to the client based upon a system policy and data obtained from the client.

100. The digital signature system of claim 91 wherein the digital signature further comprises:
a encrypted field; and
a timestamp,
wherein the server generates the encrypted field by hashing the data object according to a predefined hash function to create a hash, and encrypts the hash using the private key assigned to the user.

101. The digital signature system of claim 91 wherein the digital signature further comprises a server key.

102. The digital signature system of claim 100 further comprising:
means for generating a verification response at the server; and
means for transmitting the verification response to the client.

103. The digital signature system of claim 100 further comprising:
means for generating a verification signature for the verification response at the server; and
means for transmitting the verification signature to the client.
